(19) United States
(12) Patent Application Publication
(10) Pub. No.: US 2010/0230287 A1
(43) Pub. Date: Sep. 16, 2010

(54) POROUS GOLD MATERIALS AND PRODUCTION METHODS

(75) Inventors: Kazuyuki NISHIO, Tokyo (JP); Hideki MASUDA, Tokyo (JP)

Correspondence Address: Workman Nydegger;1000 Eagle Gate Tower, 60 East South Temple, Salt Lake City, UT, 84111, US

(73) Assignee: Tokyo Metropolitan University, Tokyo (JP)

(21) Appl. No.: 12/722,910

(22) Filed: Mar. 12, 2010

(30) Foreign Application Priority Data
Mar. 13, 2009 (JP) 2009-060560

(51) Int. Cl. B32B 15/04; C25D 11/34; C25D 5/50; C25D 5/48

(52) U.S. Cl. 205/50; 205/333; 205/224; 205/220

(57) ABSTRACT

Gold is subjected to anodic oxidation in an aqueous solution of a carboxylic acid or carboxylate. The carboxylic acid can be selected from formic acid, acetic acid, propionic acid, lactic acid, oxalic acid, malonic acid, succinic acid, maleic acid, malic acid, tartaric acid, and citric acid. The carboxylate can be selected from salts of the above-described acids. A potential applied to a gold electrode can be in the range of about +1.5 to about 11 V with respect to a potential of a standard hydrogen electrode. Thereby, a uniform porous gold film having a pore size of several nanometers to several hundreds of nanometers is formed.

### CROSS-REFERENCE TO RELATED APPLICATIONS

This application claims priority to Japanese Patent Application No. 2009-060560 filed Mar. 13, 2009, which is incorporated herein by reference.

### TECHNICAL FIELD

Embodiments relate to porous gold materials and production methods.

### BACKGROUND

Gold has been known as the chemically and electrochemically most stable metal and widely used for surface treatment by, for example, plating, electrical terminals, sensor electrodes, and so forth because of its outstanding durability. In recent years, a technique for chemically modifying gold with an organic chain molecule having a thiol group at its end has been developed and increasingly used in the field of biotechnology. Furthermore, gold particles having a diameter of about several tens of nanometers show strong interaction with visible light because of localized surface plasmon properties. Application studies using the specific optical properties have been conducted. In the case of using gold as various reaction fields, an increase in surface area significantly improves various characteristics such as reaction efficiency and provides the unique characteristics of a microstructure. It is thus useful to produce a base having a gold microstructure on its surface.

To this end, a method for forming a nanoscale porous article by dealloying, in which a gold alloy, e.g., a gold-silver alloy, is immersed in a highly toxic acidic aqueous solution and then a base metal, e.g., silver, is selectively dissolved, has often been reported (for example, see J. Erlebacher, M. J. Aziz, A. Karma, N. Dimirtov, K. Sieradzki, Nature 410, 450-453 (2001)). The method enables us to directly form a nanoscale porous gold article on a solid surface. To employ the method, however, it is essential that a uniform alloy having a strictly controlled composition should be formed. Furthermore, there are problems of cracking due to volumetric shrinkage during dealloying and the deterioration in properties due to the remaining base alloy component that acts as an impurity. Under present circumstances, it is difficult to stably produce a porous gold article by dealloying and to use it.

Alternatively, a method for forming a porous article by depositing nanoparticles formed by reduction of gold ions on a substrate, heating and fusing gold nanoparticles, and removing the substrate by sublimation or the like has been known (for example, see Japanese Unexamined Patent Application Publication No. 2007-277613). However, the surface area is extremely reduced during the fusion of nanoparticles. Furthermore a technique for forming gold-black by evaporation or plating on a substrate has been studied. However, the resulting pore size is large and thus is less likely to lead to a drastic increase in surface area.

### SUMMARY

According to aspects of the embodiments described herein, methods are provided for producing a porous gold film having uniform nanoscale pores. Embodiments also relate to substrates including a porous gold film having uniform nanoscale pores on its surface or and to a porous gold film alone.

Embodiments described herein relate to porous gold films having nanoscale pores, formed by anodic oxidation of gold in an aqueous solution of a carboxylic acid or carboxylate. Thus, embodiments described herein extend to porous gold films, substrates including a porous gold film, and methods for producing a porous gold film, as described below.

(1) A method for producing a porous gold film includes subjecting gold to anodic oxidation in an aqueous solution containing a carboxylic acid or a carboxylate.

(2) In the method described in item (1), the carboxylic acid can be at least one selected from formic acid, acetic acid, propionic acid, lactic acid, oxalic acid, malonic acid, succinic acid, maleic acid, malic acid, tartaric acid, and citric acid, and the carboxylate is preferably at least one selected from salts of formic acid, acetic acid, propionic acid, lactic acid, oxalic acid, malonic acid, succinic acid, maleic acid, malic acid, tartaric acid, and citric acid.

(3) In the method described in item (1) or (2), the anodic oxidation can be performed at a potential of +1.5 to 11 V with respect to a potential of a standard hydrogen electrode.

(4) The method described in any one of items (1) to (3) may further include after the anodic oxidation, subjecting the porous gold film to one or both of heat treatment and light irradiation.

(5) A porous gold film can be produced by the method described in any one of items (1) to (4).

(6) A substrate includes a porous gold film produced by the method described in any one of items (1) to (4).

According to aspects of the embodiments, it is possible to easily produce a porous gold film having micropores with a diameter of several nanometers to several hundreds of nanometers. Furthermore, most of carboxylic acid used is harmless to the human body. Only a low voltage is applied during anodic oxidation. Thus, the production methods are safe. Other metals do not substantially attach to the resulting porous film. It is thus possible to form a catalyst and a sensor substantially without the influence of other metals as impurities.

Such porous gold materials improve reaction efficiency when used as various reaction fields or in the case of affording a biochemical function or a sensor function by immobilizing a sugar chain, DNA, or the like on a surface of a porous gold film with an alkanethiol molecular chain or the like.

### BRIEF DESCRIPTION OF THE FIGURES

FIG. 1 is a graph showing a broken line that indicates how potential is controlled and a solid line that indicates a change in current density in an aqueous solution of oxalic acid during the anodic oxidation of gold;

FIG. 2 is an FE-SEM photograph of a fracture surface of a non-heat-treated porous gold film produced in Example 1;

FIG. 3 is an FE-SEM photograph of a fracture surface of a heat-treated porous gold film produced in Example 1; and

FIG. 4 is an FE-SEM photograph of a fracture surface of a porous gold film produced in Example 3.

### DETAILED DESCRIPTION

According to embodiments described herein, gold is subjected to anodic oxidation in an aqueous solution of a carboxylic acid or carboxylate, thereby forming a porous gold film simply and safely. To form a porous thick film by anodic oxidation of a metal, i.e., by the electrochemical corrosion reaction of a metal, while walls of pores or the entire film is passivated, the bottoms of the pores must retain their electrochemical activity. The metal having such characteristics belongs to metals classified as valve metals. The formation of porous oxide films by anodic oxidation of, traditionally, aluminum, and recently, titanium, niobium, and so forth has been reported. Meanwhile, gold does not belong to the valve metals and is very stable. It is thus difficult to explain the formation of a porous thick film by anodic oxidation on the basis of common scientific knowledge. It is also difficult to theoretically elucidate the reason for the easy formation of a porous gold film by anodic oxidation of gold in an aqueous solution of a carboxylic acid. Note that the porous gold films described herein indicate a porous film containing gold and are not limited to a porous film consisting of gold alone.

Gold to be subjected to anodic oxidation may have any composition and shape so long as a porous gold film is formed by anodic oxidation. Pure gold can be advantageously used. Gold may be in any form. In the case of using gold foil, the gold foil may be supported by an appropriate base. Alternatively, a thin gold layer may be formed by a technique, e.g., plating or evaporation, on a substrate composed of a substance other than gold. In the case of using the substrate composed of a substance other than gold, in order to prevent an electrochemical reaction from proceeding on a substrate portion, the substrate portion is preferably treated so as not to come into contact with the carboxylic acid solution.

Any carboxylic acid may be used without limitation so long as it dissolves in water. Furthermore, the carboxylic acid is not limited to the number of carboxy groups in its molecule, in other words, for example, a monovalent, divalent, or trivalent carboxylic acid may be used. To increase the solubility, the carboxylic acid may have a substituent, e.g., a hydroxy group or an amino group. Moreover, a compound other than carboxylic acid may be added. The carboxylic acid is used in the form of an aqueous solution. In this case, the concentration of the carboxylic acid is not particularly limited. Preferably, an aqueous solution with a carboxylic acid concentration to a certain extent is used from the viewpoint of achieving good reaction efficiency. Examples of the carboxylic acid include formic acid, acetic acid, propionic acid, lactic acid, oxalic acid, malonic acid, succinic acid, maleic acid, malic acid, tartaric acid, and citric acid, which have high solubility in water. For example, each of formic acid, acetic acid, lactic acid, and propionic acid is usually available in liquid form and can be used as an aqueous solution with any concentration thereof. A solid carboxylic acid is used as an aqueous solution with an acid concentration equal to or lower than the saturating concentration of the acid in view of the solubility of the acid. Citric acid is usually used as an aqueous solution having a citric acid concentration of about 3.0 mol/L at room temperature. Oxalic acid is usually used as an aqueous solution having an oxalic acid concentration of about 0.6 mol/L at room temperature. Regarding the concentration of a carboxylic acid, a higher carboxylic acid concentration results in a higher rate of formation of a porous film (for example, it takes about a night to form a porous gold film having a thickness of about 1 μm when an aqueous solution with a citric acid concentration of 0.3 mol/L is used at 0° C., whereas it takes about 30 minutes when 2.5 mol/L). Thus, usually, it is advantageous to use a carboxylic acid aqueous solution with a carboxylic acid concentration close to a saturating concentration thereof. It is useful for carboxylate ions to be present in an electrolytic solution. Thus, the use of a water-soluble carboxylate provides the same effect as that of the carboxylic acid. However, in the case where an electrolytic solution containing the carboxylate is basic, a carboxylic acid or another acid can advantageously be added thereto. While any carboxylate may be used, an alkali metal salt or ammonium salt is useful in view of its water solubility.

Meanwhile, any current and voltage applied between electrodes may be used. Excessively high values of current and voltage cause difficulty in forming a uniform porous film. The values of current and voltage vary depending on the type of acid used and are not particularly limited. A voltage is used with a value equal to or higher than a voltage at which bubbles begin to form on a gold electrode. A higher voltage allows anodic oxidation to proceed at a higher rate. However, the use of a voltage exceeding a predetermined voltage causes difficulty in forming a uniform film. An excessively lower voltage requires long-term anodic oxidation in order to form a porous gold film having a predetermined thickness. The voltage is usually determined in such a manner that the potential of a sample can be in the range of +1.5 to 11 V and advantageously about +2 to about 7 V with respect to a potential of a standard hydrogen electrode. The anodic oxidation need not be performed by applying a predetermined potential from the beginning but may be performed by gradually increasing the potential until the potential reaches a predetermined value. The reason for this is that more uniform porous gold film can be produced under the conditions. For example, in the case of using an aqueous solution of citric acid, the potential can be in the range of about +3 to about 6 V with respect to the potential of the standard hydrogen electrode. In the case of using an aqueous solution of oxalic acid, the potential can be in the range of about +2 to about 5 V with respect to the potential of the standard hydrogen electrode.

The time for the anodic oxidation varies depending on the thickness of a porous gold film, a voltage applied to electrodes, the concentration of a carboxylic acid, and so forth and is not particularly limited. A longer oxidation time typically results in an increase in the thickness of the resulting porous film. For example, in the case of using oxalic acid as a carboxylic acid, when the thickness reaches a certain value, an increase in thickness is stopped. Further electrolysis can cause the detachment of the resulting porous film. Thus, a time such that the porous film is not detached may be selected. For example, the use of citric acid can result in a film having a larger thickness than the thickness of a film produced with oxalic acid. Anodic oxidation at 0° C. for 30 minutes provides a porous gold film having a thickness of about 1 μm. Anodic oxidation at 35° C. for 12 hours provides a porous gold film having a thickness of about 100 μm.

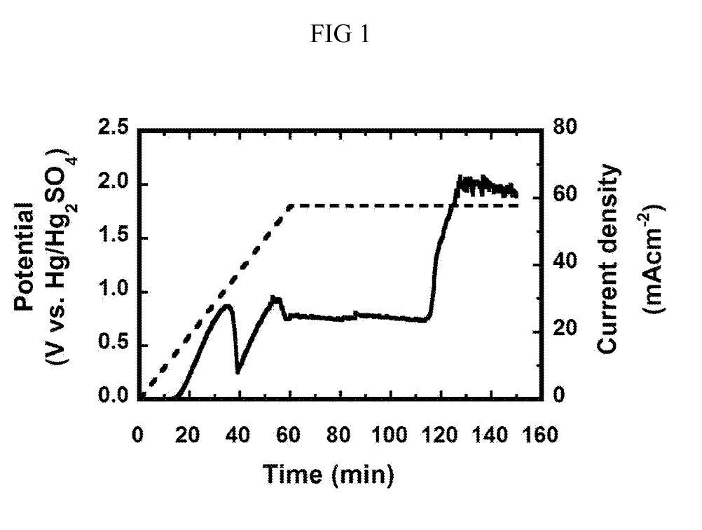

The behavior of a gold electrode during the oxidation and the characteristics of a porous film formed vary somewhat depending on an acid used. For example, a current and the behavior of the surface of a gold electrode will be described with reference to FIG. 1 when a potential of +1.8 V (value in using a mercury/mercury sulfate electrode as a reference electrode) is applied between an anode and a cathode with an aqueous solution containing 0.3 mol/L oxalic acid. In the case where the potential is gradually increased from 0 V to +1.8 V at a rate of +1 mV/s and then maintained at a constant voltage of +1.8 V, after the start of the application of the voltage, the current is first increased, sharply reduced at about +1.0 V, and then recovered, as indicated by a solid line shown in FIG. 1. This behavior is similar to behavior in forming a typical passive film. Bubbles are formed on the electrode surface after the recovery of the current. The current stabilizes at about 20 mAcm⁻² for about 60 minutes after the potential is held at +1.8 V. Thereafter, the current is sharply increased and then maintained at a substantially constant value. The gold electrode that has been subjected to anodic oxidation has a uniformly black surface.

Meanwhile, for example, in the case of anodic oxidation of gold in an aqueous solution of citric acid, the surface of a gold electrode after the anodic oxidation is bright orange together with interference colors. The surface blackens gradually with time. The pore size of the resulting porous film is smaller than that of a film produced with oxalic acid. While differences in characteristics among porous films produced with different carboxylic acids and mechanisms for the formation of the porous films are unclear at present, the embodiments described herein are not limited thereto.

For example, a porous gold film formed with citric acid is unstable even at room temperature and blackens gradually. However, heat treatment or light irradiation (exposure) allows the blackening of the resulting porous gold film to proceed, thereby improving the stability of the film.

It is possible to form porous gold films with nanoscale pores each having a diameter of, for example, several nanometers to several hundreds of nanometers on substrates composed of gold and other materials by selecting anodic oxidation conditions, for example, the types of carboxylic acid and carboxylate, concentrations thereof, and voltage. Immobilization or modifications of various substances on surfaces of porous gold films on substrates will make it possible to produce biochemical sensors and catalytic reaction systems. Furthermore, for example, gold is deposited by evaporation on an aluminum surface. A portion other than gold is then masked. Anodic oxidation is performed, thereby forming a porous gold film on the surface of a material other than gold. Moreover, anodic oxidation under appropriate conditions separates a porous gold film from a substrate composed of a material other than gold, thereby affording the porous film alone. To form a porous gold powder, after the formation of a porous film, the film may be mechanically separated from a substrate.

### EXAMPLES

While the embodiments will be described in detail by examples, they are not limited to the examples.

### Example 1

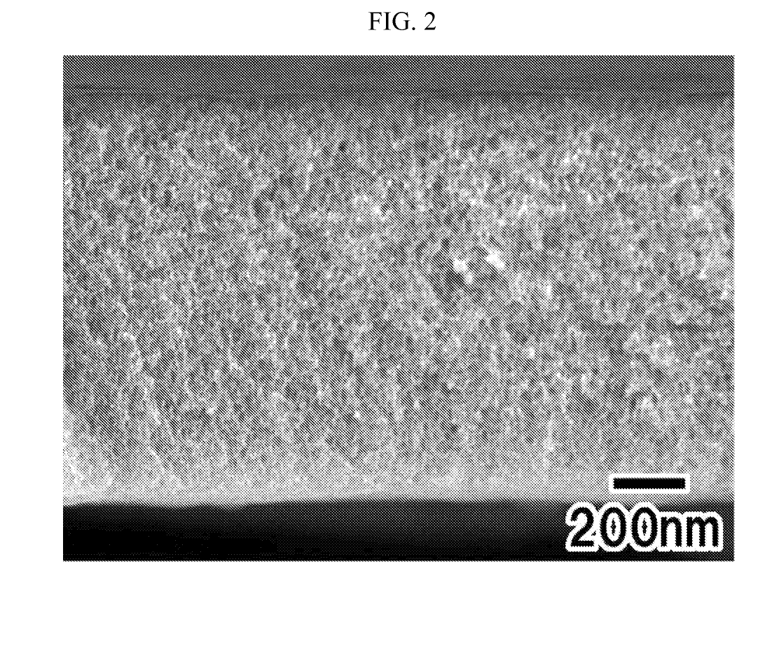

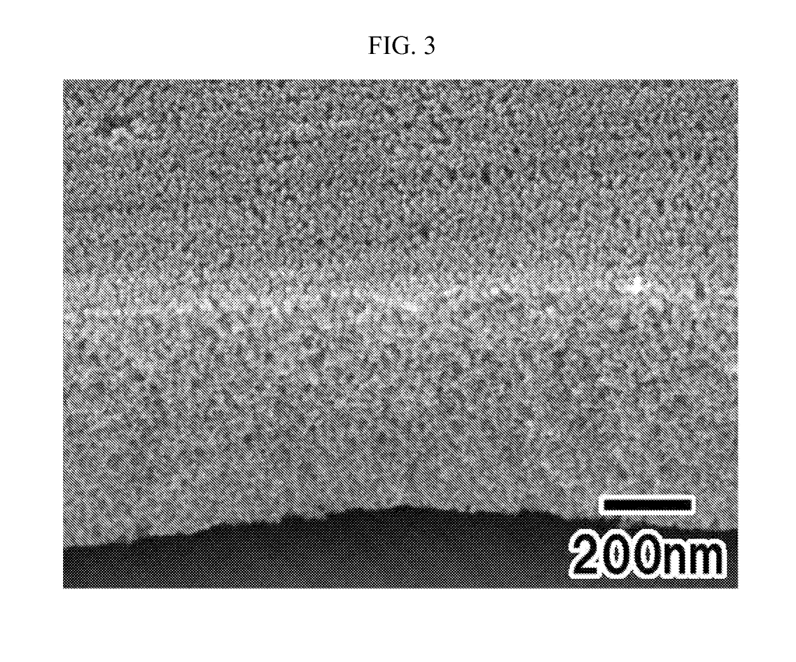

A surface of gold foil with a purity of 99.95% was polished with alumina paste. The gold foil was used as an anode. An aqueous solution containing 2.5 M citric acid was prepared as an electrolytic solution at 0° C. A carbon plate was used as a counter electrode. A Hg/Hg₂SO₄ electrode (about +0.64 V/SHE) was used as a reference electrode. Anodic oxidation was performed at a potential of +4 V (voltage with respect to the reference electrode) applied to the gold electrode and at a current density of about 25 mAcm⁻² for 30 minutes. After the completion of the anodic oxidation, the gold electrode was taken out. The surface of the gold electrode was bright orange at first and then blackened gradually. FIG. 2 is an FE-SEM photograph of a fracture surface of the gold film formed by the anodic oxidation. As shown in FIG. 2, a uniform porous film having a thickness of about 1 μm was formed. Note that no apparent difference was observed in the structure of the porous film before and after the blackening. The black film was mechanically separated from the substrate. BET surface area measurement showed that the film had a specific surface area of about 60 M²g⁻¹ and a mean pore size of about 7 nm. In the case where immediately after the anodic oxidation, the gold electrode was subjected to heat treatment at 200° C., a more stable black film was quickly formed. FIG. 3 is an FE-SEM photograph of a fracture surface of the gold film after the heat treatment at 200° C. FIG. 3 demonstrated that although the pore size was slightly increased, the fine porous structure was maintained. The progression of such blackening was also observed by light irradiation using a mercury lamp.

### Example 2

Anodic oxidation was performed at about 25 mAcm⁻² as in Example 1, except that the anodic oxidation was performed at 35° C. for 12 hours. Thereby, a porous gold film having a thickness of about 100 μm was formed.

### Example 3

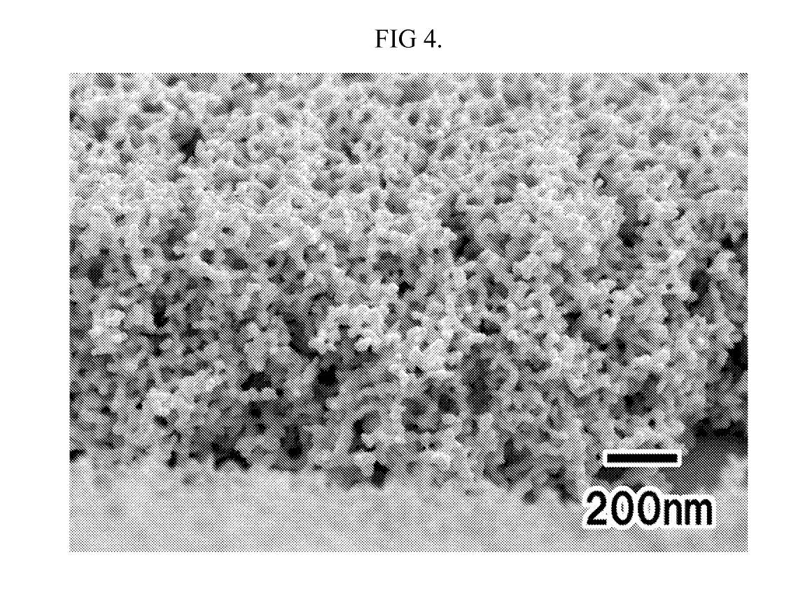

A surface of gold foil with a purity of 99.95% was polished. The area of an electrode was set to about 1 cm². Anodic oxidation was performed in an aqueous solution of 0.3 M oxalic acid while the potential was controlled. A mercury/mercury sulfate electrode (about +0.64 V/SHE) was used as a reference electrode. A carbon plate was used as a counter electrode. The potential was controlled as indicated by a broken line shown in FIG. 1. That is, the potential was increased from 0 V to +1.8 V at a rate of +1 mV/s and then maintained at +1.8 V. The anodic oxidation was terminated 90 minutes after the potential reached +1.8 V. After the completion of the anodic oxidation, the surface of the gold electrode was uniformly black. The fracture surface of the black film was observed with an FE-SEM. FIG. 4 is an FE-SEM photograph. The resulting film was determined to be a uniform porous film having a thickness of about 800 nm and a three-dimensional network structure with a pore size of about 30 nm.

A porous gold film according to embodiments described herein is usable as a catalyst or a biochemical sensor by chemical modification or immobilization of a functional material such as an enzyme and thus is usable in various industrial fields.

What is claimed is:

1. A method for producing a porous gold film, comprising:
subjecting gold to anodic oxidation in an aqueous solution containing a carboxylic acid or a carboxylate.

2. The method according to claim 1, wherein:
the carboxylic acid is at least one selected from formic acid, acetic acid, propionic acid, lactic acid, oxalic acid, malonic acid, succinic acid, maleic acid, malic acid, tartaric acid, and citric acid, and
the carboxylate is at least one selected from salts of formic acid, acetic acid, propionic acid, lactic acid, oxalic acid, malonic acid, succinic acid, maleic acid, malic acid, tartaric acid, and citric acid.

3. The method according to claim 1, wherein the anodic oxidation is performed at a potential of +1.5 to 11 V with respect to a potential of a standard hydrogen electrode.

4. The method according to claim 1, further comprising:
after the anodic oxidation, subjecting the porous gold film to one or both of heat treatment and light irradiation.

5. A porous gold film produced by a method that comprises:
subjecting gold to anodic oxidation in an aqueous solution containing a carboxylic acid or a carboxylate.

6. The porous gold film according to claim 5, wherein:
the carboxylic acid is at least one selected from formic acid, acetic acid, propionic acid, lactic acid, oxalic acid, malonic acid, succinic acid, maleic acid, malic acid, tartaric acid, and citric acid, and
the carboxylate is at least one selected from salts of formic acid, acetic acid, propionic acid, lactic acid, oxalic acid, malonic acid, succinic acid, maleic acid, malic acid, tartaric acid, and citric acid.

7. The porous gold film according to claim 5, wherein the anodic oxidation is performed at a potential of +1.5 to 11 V with respect to a potential of a standard hydrogen electrode.

8. The porous gold film according to claim 5, wherein the method further comprises:
after the anodic oxidation, subjecting the porous gold film to one or both of heat treatment and light irradiation.

9. The porous gold film according to claim 5, wherein the porous gold film is incorporated into an article that performs a biochemical function.

10. The porous gold film according to claim 5, wherein the porous gold film is incorporated into an article that performs a sensor function.

11. The porous gold film according to claim 5, wherein the porous gold film is incorporated into an article that performs a catalytic function.

12. The porous gold film according to claim 5, wherein the porous gold film has a surface on which a sugar chain or DNA can be immobilized.

13. A substrate comprising:
a porous gold film produced by a method that comprises:
subjecting gold to anodic oxidation in an aqueous solution containing a carboxylic acid or a carboxylate.

14. The substrate according to claim 13, wherein:
the carboxylic acid is at least one selected from formic acid, acetic acid, propionic acid, lactic acid, oxalic acid, malonic acid, succinic acid, maleic acid, malic acid, tartaric acid, and citric acid, and
the carboxylate is at least one selected from salts of formic acid, acetic acid, propionic acid, lactic acid, oxalic acid, malonic acid, succinic acid, maleic acid, malic acid, tartaric acid, and citric acid.

15. The substrate according to claim 13, wherein the anodic oxidation is performed at a potential of +1.5 to 11 V with respect to a potential of a standard hydrogen electrode.

16. The substrate according to claim 13, wherein the method further comprises:
after the anodic oxidation, subjecting the porous gold film to one or both of heat treatment and light irradiation.
